(19) United States
(12) Patent Application Publication
(10) Pub. No.: US 2026/0057299 A1
(43) Pub. Date: Feb. 26, 2026

(54) METHODS, SYSTEMS, AND STORAGES OF CAUSAL MODEL OFFLINE EVALUATION AND LEARNING FOR PERSONALIZED DECISION SYSTEMS

(71) Applicant: HEDONG YAN, TAIAN (CN)

(72) Inventor: HEDONG YAN, TAIAN (CN)

(73) Assignee: HEDONG YAN, TAIAN (CN)

(21) Appl. No.: 19/300,759

(22) Filed: Aug. 15, 2025

(30) Foreign Application Priority Data
Aug. 24, 2024 (CN) 2024111694541

(51) Int. Cl. G06N 20/00

(52) U.S. Cl. CPC G06N 20/00

(57) ABSTRACT

The present disclosure provides an offline method for causal model evaluation and adaptive learning engine for personalized decision-making, along with exemplary implementations thereof, comprising a specialized causal model evaluation method and a causal model learning method. The evaluation method disclosed herein utilizes randomized experimental data to estimate the decision utility of a causal model by computing its pseudo-decision utility via a quasi-randomized procedure. The learning method disclosed herein optimizes the decision outputs of a causal model by learning optimal decision group labels. The evaluation method exhibits weak dependence on assumptions regarding the data and the causal model under evaluation, does not rely on individual-level covariates, has wide applicability, avoids the problem of unobserved confounding, and produces evaluation results that are directly tied to the decision utility. The learning method yields models that achieve high personalized decision utility, is user-friendly, and is suitable for data-driven personalized decision systems.

### CROSS-REFERENCE TO RELATED APPLICATIONS

This application is a continuation of claims priority of Chinese Patent Application No. 2024111694541, filed on Aug. 24, 2024, the contents of which are hereby incorporated by reference.

### TECHNICAL FIELD

The present disclosure relates to causal models for personalized decision systems, and more particularly, to methods, systems, and storages for evaluating and learning causal models applied in personalized decision-making.

### BACKGROUND

With the rapid development of big data and machine learning technologies, personalized decision systems have found widespread applications in various fields such as personalized credit, recommendation systems, healthcare, and marketing. These systems make personalized decisions for individual units (e.g., users or patients) to achieve specific goals (e.g., higher interest income, increased user click-through rates, disease prevention, stock profits, media engagement) based on historical behavior and features.

Conventional systems primarily rely on correlation-based predictive models, which identify linear or nonlinear correlations between historical features, past decisions, and outcome variables to predict future outcomes. However, this approach has inherent limitations, such as the inability to determine whether different decisions would have led to better outcomes due to unobserved or unmeasurable confounding factors.

For example, when evaluating the effect of a new drug on the recovery outcomes of patients with heart disease, real-world observational data may suggest that patients receiving the new treatment recover more slowly than those who do not. However, without accounting for confounding factors—such as patient age, sex, lifestyle, or dietary habits—it is unclear whether patients who did not receive the new drug would have recovered even more slowly. This may lead to an incorrect estimation of the causal effect of the drug on recovery speed.

To address these limitations, researchers have started adopting causal models to improve personalized decision-making. Continuous efforts have been made to enhance the evaluation and learning of such models.

Existing methods mainly include evaluating and learning from synthetic data or based on predictive performance. However, personalized decisions must rely on real individual data. Synthetic data either fail to reflect real-world causal relations or imply that a real-world generative model has already been discovered, eliminating the need for further model learning. Moreover, predictive performance does not account for counterfactual outcomes or unknown confounders, leading to potentially incorrect causal models.

Therefore, there is an urgent need for new evaluation and learning methods for causal models, especially in real-world personalized decision systems like recommendations, healthcare, credit, and marketing. Increasingly, researchers are abandoning synthetic data and predictive metrics in favor of methods grounded in real-world experimentation.

Recently, randomized experimental data has emerged as a robust basis for evaluating and learning causal models. The availability of such data highlights the limitations of observational and synthetic data, as well as the risks of misestimating decision value.

### SUMMARY

This disclosure proposes methods and systems for evaluating and learning causal models using offline randomized trial data, generating optimal group labels to inform decisions. These methods apply to a wide range of systems and provide a novel framework for offline causal evaluation and learning.

Specifically, the present disclosure describes a system and method for the evaluation and learning of causal models. The system and method are implemented as computer programs for causal model learning and evaluation in personalized decision-making systems, executable on one or more computers located at one or more sites.

Evaluation of a causal model f can be achieved via the following processes:
process 101: Obtain the model f and a test dataset Ste={zi}_{i=1}\hat{ }{n_{te}}, and configure the evaluation protocol.
process 102: Input the features X of each unit z in Ste into model f to generate decision labels G. Group units with the same G into group i.
process 103: For each group i, compute the difference matrix D_i(j,k) of potential outcomes under different decisions j and k.
process 104: Calculate the individual causal effect for each unit based on group label, potential outcome differences D(i,j,k), and a benefit function B(z).

The learning for a causal model f is implemented via:
process 201: Obtain the model f and a training dataset Str={zi}_{i=1}\hat{ }{n_{tr}}, and configure the learning protocol.
process 202: Determine decision thresholds Y0 from the outcome variable Y.
process 203: Assign optimal group labels G based on A, Y, and threshold Y0.
process 204: Learn a model f: X->G using features X and optimal labels G.
In certain embodiments, process 201 comprises:
acquiring a causal model f for training and a training dataset $S_{tr}={z_i}_{i=1}\hat{ }{n_{tr}}$ comprising multiple units, and completing configuration of a learning method;
wherein the decision variable A for each unit z in said training dataset $S_{tr}$ is generated through a randomization process, with each observed record of unit z constituting a data tuple (X, A, Y), where:
   X represents feature variables before application of decision variable A;
   A represents an applied decision variable;
   Y represents a target variable of unit z after application of decision variable A;
data types of said feature variables X and decision variable A include, but are not limited to: numerical, categorical, textual, tabular, or any combination thereof;
upon completing configuration of the evaluation method, performing encoding of feature variables X, decision variables A, and target variables Y.

In certain implementations, process 101 comprises:
acquiring a causal model f for evaluation and a test dataset $S_{te}={z_i}_{i=1}\hat{ }{n_{te}}$ containing multiple units, and completing configuration of an evaluation method;
wherein the decision variable A for each unit z in said test dataset $S_{te}$ is randomly generated, and an observed record of unit z constitutes a data tuple (X, A, Y), where:
   X represents feature variables immediately preceding application of decision variable A;
   A represents an applied decision variable;
   Y represents a target variable of unit z subsequent to application of decision variable A;
data types of said feature variables X and decision variable A include, without limitation: numerical, categorical, tabular, textual, or any combination thereof;
upon completing configuration of the evaluation method, executing encoding operations on feature variables X, decision variables A, and target variables Y.
wherein the feature variables of a data unit comprise features and records that either uniquely identify a unit or narrow its entity scope;
the feature variable types include, without limitation: discrete numerical values, continuous numerical values, categorical data, tabular records, text, graphics, images, animations, audio, video, sensor data,
or any combination thereof; and may exist as: static data, time-series data, or any combination thereof; including but not limited to: electronic health records and vital sign monitoring streams of patients, personal information and operational interaction streams of users.

Wherein the decision variable of a data unit represents specific decisions or actions taken by the personalized decision-making system for that unit. The decision variable types may include but are not limited to: binary Boolean variables, multi-valued discrete variables, or any combination thereof, such as whether to display a pop-up reminder to a patient, which products to push to a user, discount amounts for users, or personalized pricing for users. They may be one-dimensional or multi-dimensional variables, or any combination thereof, such as pushed text, images, audio, or video.

Wherein the target variable of a data unit represents specific attributes of the unit that the personalized decision-making system intends to intervene or measure after taking specific decisions or actions. The target variable types may include but are not limited to: binary values, multi-values, or any combination thereof, such as whether a patient dies or a user makes a purchase, user rating levels, or total user repayment amounts. They may be one-dimensional or multi-dimensional variables, or any combination thereof, such as whether disease progression occurs or multi-dimensional physiological indicators.

In some specific implementations, said process 202 includes determining the target variable boundary point $Y_0=[Y_0\hat{ }1, Y_0\hat{ }2, . . . , Y_0\hat{ }{D_Y}]$ based on the target variable Y of multiple units in the training dataset $S_{tr}={z_i}_{i=1}\hat{ }{n_{tr}}$; where $D_Y$ is the dimension of Y, and the target boundary point $Y_0$ is determined by a target boundary function F. This function F takes the target variable Y of all units used for training as input and outputs the target variable boundary point $Y_0$.

The function F may be a sample statistic of the target variable Y, including but not limited to: maximum M quantiles, maximum M equal divisions of the target variable Y range, other statistics, or any combination thereof, where M is the number of possible values of the decision variable A.

In some specific implementations, said process 203 includes, for multiple units in the training dataset $S_{tr}={z_i}{i=1}\hat{ }{n{tr}}$, grouping the units based on the target variable boundary point $Y_0$ and the unit's decision variable A and target variable Y, thereby generating an optimal group label as the optimal decision label G for the unit. First, units with $A=i$ and $Y>Y_0$ are marked as group i. Units with $A=i$ and $Y<Y 0$ are assigned to groups other than i according to a selected residual unit allocation method $G=R(A, Y)$. The group label of the unit is then used as the variable G to be predicted, i.e., the optimal decision label G for each unit. The total number of groups is M, with group labels being 0,1, . . . ,M−1 respectively.

The selected residual unit allocation method $G=R(A, Y) $ includes but is not limited to: assigning units with $A=i$ and $YSY_0$ to other groups (not i) with equal probability randomly, or assigning units with $A=i$ and $YSY_0$ to other groups (not i) in rotation after sorting by Y value.

In some specific implementations, said process 204 includes learning a causal model $f:X→G$ based on the feature variables X and optimal decision labels G of multiple units in the training dataset $S_{tr}={z_i}{i=1}\hat{ }{n{tr}}$. The input X of the predictive model f is the feature variables of the unit, and the output is the optimal decision label G.

When learning and selecting the causal model f based on predictive metrics, the metrics include but are not limited to: precision, recall, F1-Score, PR-AUC, ROC-AUC, other metrics derived from confusion matrices (e.g., F2-Score), or any combination thereof.

The causal model f to be learned may be a linear classification model, Bayesian classification model, decision tree classification model and its improvements (e.g., XGBoost, LightGBM, CatBoost, etc.), fully connected neural network classification model, ResNet classification model, Transformer architecture-based pre-trained large classification model (e.g., TabPFN), other classification models (e.g., KNN classification), or any combination thereof.

When using the causal model f, for a specific unit z, make its one-to-one corresponding decision A according to the output G of the causal model f.

In some specific implementations, said process 102 includes, for multiple units in the test set $S_{te}={z_i}_{i=1}\hat{ }{n_{te}}$, inputting the feature variables X of unit z in the test dataset into the causal model f to obtain the output G of the causal model, and grouping test units with the same proposed decision value G of the causal model f into the same group. The input of the causal model f is the feature variable X of unit z, the output is the proposed decision G for that unit z. The group labels of test units are 0,1, . . . , M−1 respectively, where M is the number of possible values of the proposed decision group G and also the number of possible values of the decision variable A.

In some specific implementations, said process 103 includes calculating the difference matrix $D_i(j,k)$ of potential outcomes when the decision variables of units in each proposed decision group i take different values j,k. The matrix $D_i$ has M rows and M columns, where the element at row j and column k is $Y_i\hat{ }{A=k}−Y_i{A=j}$. The potential outcome $Y_i\hat{ }{A=j}$ represents the expected value of the target variable Y measurement result of a specific unit z in the i-th proposed decision group if it executes decision j. When inferring the potential outcome $Y_i\hat{ }{A=j}$ of units in the i-th group, sample statistics of the target variable Y of samples in the i-th proposed decision group with decision variable value j are used, including but not limited to: mean, median, other statistics (e.g., weighted mean), or any combination thereof.

In some specific implementations, said process 104 includes calculating the causal utility of the causal model f for each unit decision based on the decision causal utility function B(z), the proposed decision group label i of unit z, and the potential outcome difference tensor D(i,j,k). The decision causal utility function B(z) may be the sample statistic of the i-th column of the potential outcome difference matrix $D_i$ of group i (where unit z belongs) with the i-th row element removed, including but not limited to: mean, median, maximum, other statistics (e.g., quartiles), or any combination thereof.

Furthermore, after calculating the decision causal utility for each unit based on the decision causal utility function B(z), the proposed decision group label of unit z, and the potential outcome difference tensor D(i,j,k), the total decision causal utility is the sum of the decision causal utility of all units, and the average decision causal utility is the total decision causal utility divided by the number of units.

Compared with prior art, specific implementations of the subject matter described in the present disclosure may achieve one or more of the following advantages: The evaluation method of the present disclosure requires weak data assumptions and has broad applicability. It does not rely on any conditional independence assumptions, causal directions, or causal graph assumptions regarding possible relationships between feature variables, decision variables, target variables, and latent variables. It does not rely on any assumptions about the form of latent or other variables, any specific functional strong assumptions about relationships between variables, or any assumptions about the effect of decision variables on target variables. There are no restrictions on or dependencies of the model to be evaluated, thus eliminating the need to formulate any such assumptions and avoiding risks of incorrect assumptions. The learning method of the present disclosure can significantly improve the performance of causal models by learning optimal groupings. The present disclosure provides a new option for evaluating and learning causal models applied to personalized decision-making systems and facilities.

### BRIEF DESCRIPTION OF THE DRAWINGS

FIG. 1 is a schematic block diagram of the evaluation and learning for causal models applied to personalized decision-making systems according to the present disclosure.

FIG. 2 is a schematic block diagram of the evaluation method for causal model individual utility, total utility, and average utility when the decision variable is ternary and the decision causal utility function B(z) is the median of the i-th column with the i-th row element removed from the potential outcome difference matrix $D_i$ of group i where unit z belongs.

FIG. 3 illustrates the optimal decision label generation process for all units when the decision variable is ternary and the residual unit allocation method is equal probability random assignment.

### DETAILED DESCRIPTION OF THE EMBODIMENTS

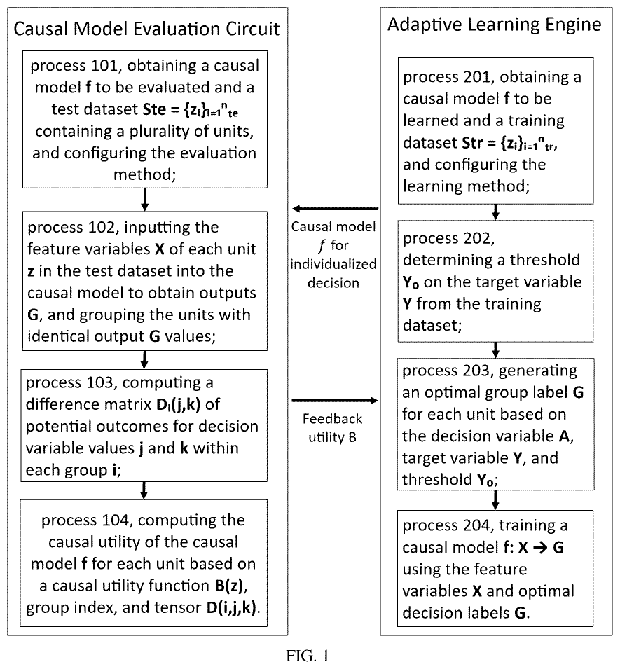

The following further describes the present disclosure in detail with reference to the best embodiments shown in the drawings: The schematic block diagram of the present disclosure for evaluating and learning causal models for personalized decision-making systems is shown in FIG. 1. In the following specific embodiments, the present disclosure first learns the causal model using the causal model learning method of processes 201, 202, 203, 204, and then evaluates it using the causal model evaluation method of processes 101, 102, 103, 104.

Specific Embodiment 1 involves learning and evaluating a causal model for personalized acute kidney injury electronic health record alerts to improve 14-day mortality of acute kidney injury patients after admission.

In this specific embodiment, data for processes 201 and 101 come from a double-blind, multicenter, parallel, randomized, controlled trial involving 6,030 adult patients with acute kidney injury defined by KDIGO creatinine criteria across four teaching hospitals and two non-teaching hospitals (including community hospitals and large care centers).

The target variable Y in this embodiment is the patient's death status within 14 days after randomization intervention, with death encoded as 0 and survival as 1.

The randomized decision variable or intervention A in this embodiment is an electronic health record-based pop-up alert window that appears when a physician opens the patient's medical record. Absence of pop-up alert is encoded as 0, presence as 1.

There are 47 feature variables X in this embodiment, including numerical, categorical, text, and tabular data: Age; Age≥90 years; Gender; Hispanic ethnicity; African American race; Hospital; Medical admission; History of hypertension; History of diabetes; History of COPD; History of chronic kidney disease; History of congestive heart failure; History of acute kidney disease; History of liver disease; History of malignancy; Received ACEI/ARB/renin inhibitor antihypertensive within 24 hours; Received ACEI/ARB/renin inhibitor antihypertensive within 72 hours; Received NSAID within 24 hours; Received NSAID within 72 hours; Received aminoglycoside within 24 hours; Received PPI within 72 hours; Underwent contrast procedure within 72 hours; Underwent CT procedure within 7 days; Hours from AKI onset to randomization; Days from trial start date to randomization; Hours from admission to randomization; Pulse at randomization; Respiratory rate at randomization; Systolic BP measurement at randomization; Diastolic BP measurement at randomization; Baseline creatinine measurement; Minimum creatinine within 48 hours; Bicarbonate at randomization; BUN at randomization; Chloride at randomization; Creatinine at randomization; Platelet count at randomization; WBC at randomization; Hemoglobin at randomization; Sodium at randomization; Potassium at randomization; Anion gap at randomization; Elixhauser comorbidity index; Simplified acute physiology score; In ER at randomization; eGFR at admission; Whether patient was randomized in hospital ward.

Specifically, 80% of the dataset is randomly selected as the training dataset $S_{tr}={z_i}_{i=1}\hat{ }{4824}$, and the remaining 20% as the test dataset $S_{te}={z_i}_{i=4825}\hat{ }{6030}$.

In some implementations, said processes 202 includes using the maximum bisection point as the target boundary function to determine the target variable boundary point $Y_0=0.5$.

In some implementations, said processes 203 includes marking acute kidney injury patients without pop-up alerts and without death within 14 days as group 0; marking patients with pop-up alerts and without death within 14 days as group 1; for the remaining units, assigning them to other groups in rotation after sorting by Y value: marking acute kidney injury patients with pop-up alerts who died within 14 days as group 0; and marking patients without pop-up alerts who died within 14 days as group 1.

In some implementations, said processes 204 includes learning a predictive model $f:X→G$ based on the feature variables X and optimal decision labels G of units in the training dataset $S_{tr}={z_i}_{i=1}\hat{ }{4824}}$. Specifically, the input of the predictive model f is the 47 feature variables X of the units, and the output is the optimal decision label G. Here, the CatBoost tree classification model is used for learning, denoted as $f_1$. The parameters of the CatBoost tree classification model are set to Python's catboost package defaults, with ROC-AUC as the model selection metric. As a control group, the CatBoost tree classification model with default settings is also used to learn predictive model $f_0:(X,A)→Y$, and the control model decision variable is obtained using $T_i=\arg\max_A\hat{Y}(X_i,A)$, i.e., selecting the decision that the predictive model believes would result in a lower probability of patient death within 14 days.

In some implementations, said processes 102 includes, given the causal models $f_1$, $f_0$ to be evaluated and the test dataset $S_{te}={z_i}_{i=4825}\hat{ }{6030}$, inputting the feature variables X of units in the test dataset into the causal models to obtain the proposed decisions G, and grouping test units with the same output value G of the causal model into the same group, with group labels being proposed no-popup group 0 and proposed popup group 1 respectively.

In some implementations, said processes 103 includes calculating the potential outcome difference matrix for group 0 units: $D_0=\begin{bmatrix}0 & Y_0\hat{ }{A=1}−Y_0\hat{ }{A=0}\Y_0\hat{ }{A=0}−Y_0\hat{ }{A=1}&\end{bmatrix}$ and for group 1 units: $D_1=\begin {bmatrix}0 & Y_1\hat{ }{A=1}−Y_1\hat{ }{A=0}\Y_1\hat{ }{A=0}−Y_1\hat{ }{A=1}& 0\end{bmatrix}$, where the potential outcome $Y_i\hat{ }{A=j}$ represents the expected value of the target variable Y measurement result of a specific unit z in group i if it executes decision j. When inferring the potential outcome $Y_i\hat{ }{A=j}$ of units in group i, the median of the target variable Y of samples in group i with decision variable value j is used.

In some implementations, said processes 104 includes calculating the decision causal utility for each unit based on the decision causal utility function B=B(z), the proposed decision group label of unit z, and the potential outcome difference tensor D(i,j,k). The decision causal utility function is the mean of the i-th column with the i-th row element removed from the potential outcome difference matrix $D_i$ of the group i where unit z belongs. Specifically:

For units in proposed no-popup group 0: $B_0=Y_0\hat{ }{A=0}−Y_0\hat{ }{A=1}$

For units in proposed popup group 1: $B_1=Y_1\hat{ }{A=1}−Y_1\hat{ }{A=0}$

The total decision causal utility for all units is the sum of decision causal utility of all units: $B_{sum}=n_0B_0+n_1B_1$

The average decision causal utility is the total utility divided by the number of units: $B_{ave}=B_{sum}/n$
where $n_1$ is the number of proposed popup group units in the test set, $n_0$ is the number of proposed no-popup group units, and n is the total number of units in the test set.

The experiment was repeated 1000 times and averaged, with significance tested using two-sample t-test. The results show that the model $f_1$ trained with the learning method of this embodiment significantly reduced mortality from 8.92% to 7.37% (causal decision average utility=1.55% mortality reduction), while the control model $f_0$ reduced mortality non-significantly from 8.92% to 8.59% (causal decision average utility =0.33% mortality reduction).

Specific Embodiment 2 involves learning and evaluating a causal model for personalized male/female/random-identity large model chatbot groups replying to user tweets about sports, entertainment, or lifestyle to enhance user likes on media news.

In this specific embodiment, data for processes 201 and 101 come from a two-week randomized trial on a social media platform involving 28,457 users using 28 male or female identity GPT-2 large model chatbots to automatically reply to enhance user engagement with media news. Specifically, 80% of the dataset is randomly selected as the training dataset $S_{tr}={z_i}{i=1}\hat{ }{22765}$, and the remaining 20% as the test dataset $S_{te}={z_i}_{i=22766}\hat{ }{28457}$.

The target variable Y in this embodiment is the increment of user likes on media content news.

The randomized decision variable A is which large model chatbot group replies to user posts: all-feminized chatbot group interaction encoded as 0, all-masculinized chatbot group interaction encoded as 1, random-gender chatbot group interaction encoded as 2.

There are 11 feature variables X in this embodiment, including numerical and text data: Number of lists in account features, number of likes from account, number of posts from account, number of accounts followed by user, number of accounts following user, most frequent tweet category of user, media news likes before interaction, number of media followed before interaction, media news retweets before interaction, media news likes before interaction.

In some implementations, said process 202 includes using a target boundary function $Y_0=\text{Average}(Y_{tr})$, where the Average function takes the mean of target variable Y of units in the training dataset, thus determining the target variable boundary point $Y_0=0.51$.

In some implementations, said process 203 includes, as shown in FIG. 3:
Marking users with feminized chatbot group interaction and post-interaction media news likes exceeding $Y_0$ as group 0
Marking users with masculinized chatbot group interaction and post-interaction media news likes exceeding $Y_0$ as group 1
Marking users with random-gender chatbot group interaction and post-interaction media news likes exceeding $Y_0$ as group 2

For remaining units, using an equal probability random assignment strategy:
Users with feminized interaction and likes not exceeding $Y_0$: 50% marked as group 1 and 50% as group 2
Users with masculinized interaction and likes not exceeding $Y_0$: 50% marked as group 0 and 50% as group 2
Users with random-gender interaction and likes not exceeding $Y_0$: 50% marked as group 0 and 50% as group 1

The grouping of units serves as the new predicted variable G, i.e., the optimal decision label for each unit, which has a one-to-one correspondence with the value of decision variable A.

In some implementations, said process 204 causal model learning includes learning predictive model $f:X→G$ based on feature variables and optimal decision labels of units in training dataset $S_{tr}={z_i} _{i=1}\hat{ }{22765}}$. Specifically, the input of predictive model f is the 11 feature variables X of the units, and the output is the optimal decision label G. Here, the XGBoost tree classification model is used for learning, denoted as $f_1$. The parameters of the XGBoost tree classification model are set to Python's xgboost package defaults, with F2-Score as the model selection metric. As a control group, the XGBoost tree regression model with default configuration is also used to learn predictive model $f_0:(X,A)→Y$, with parameters set to Python's xgboost package defaults. The decision variable is obtained using $T_i=\arg\max_A\hat{Y}(X_i,A)$, i.e., selecting the decision that the model believes would result in higher post-interaction media news like increment for the user.

In some implementations, said process 102 includes, given the causal models $f_1$, $f_0$ to be evaluated and test dataset $S_{te}={z_i}_{i=22766}\hat{ }{28457}$, inputting the feature variables X of units in the test dataset into the causal models to obtain the proposed decisions G, and grouping test units with the same output value G of the causal model into the same group, with group labels being: proposed feminized large model group interaction group 0, proposed masculinized large model group interaction group 1, and proposed random-gender large model group interaction group 2.

In some implementations, said process 103 includes calculating:

Potential outcome difference matrix for group 0 units:

$D_0=\begin{bmatrix} 0 & Y_0\hat{ }{A=1}−Y_0\hat{ }{A=0} &
Y_0\hat{ }{A=2}−Y_0\hat{ }{A=0} \ Y_0\hat{ }{A=0}−Y_0\hat{ }{A=1} & 0 &
Y_0\hat{ }{A=2}−Y_0\hat{ }{A=1} \ Y_0\hat{ }{A=0}−Y_0\hat{ }{A=2} &
Y_0\hat{ }{A=1}−Y_0\hat{ }{A=2} & 0 \end{bmatrix}$

For group 1 units:

$D_1=\begin{bmatrix} 0 & Y_1\hat{ }{A=1}−Y_1\hat{ }{A=0} &
Y_1\hat{ }{A=2}−Y_1\hat{ }{A=0} \ Y_1\hat{ }{A=0}−Y_1\hat{ }[A=1} & 0 &
Y_1\hat{ }{A=2}−Y_1\hat{ }{A=1} \ Y_1\hat{ }{A=0}−Y_1\hat{ }{A=2} &
Y_1\hat{ }{A=1}−Y_1\hat{ }{A=2} & 0 \end{bmatrix}$

For group 2 units:

$D_2=\begin{bmatrix} 0 & Y_2\hat{ }{A=1}−Y_2\hat{ }{A=0} &
Y_2\hat{ }{A=2}−Y_2\hat{ }{A=0} \ Y_2\hat{ }{A=0}−Y_2\hat{ }{A=1} & 0 &
Y_2\hat{ }{A=2}−Y_2\hat{ }{A=1} \ Y_2\hat{ }{A=0}−Y_2\hat{ }{A=2} &
Y_2\hat{ }{A=1}−Y_2\hat{ }{A=2} & 0 \end{bmatrix}$

where the potential outcome $Y_i\hat{ }{A=j}$ represents the expected value of the target variable Y measurement result of a specific unit z in group i if it executes decision j. When inferring the potential outcome $Y_i\hat{ }{A=j} of units in group i, the mean of the target variable Y of samples in group i with decision variable value j is used.

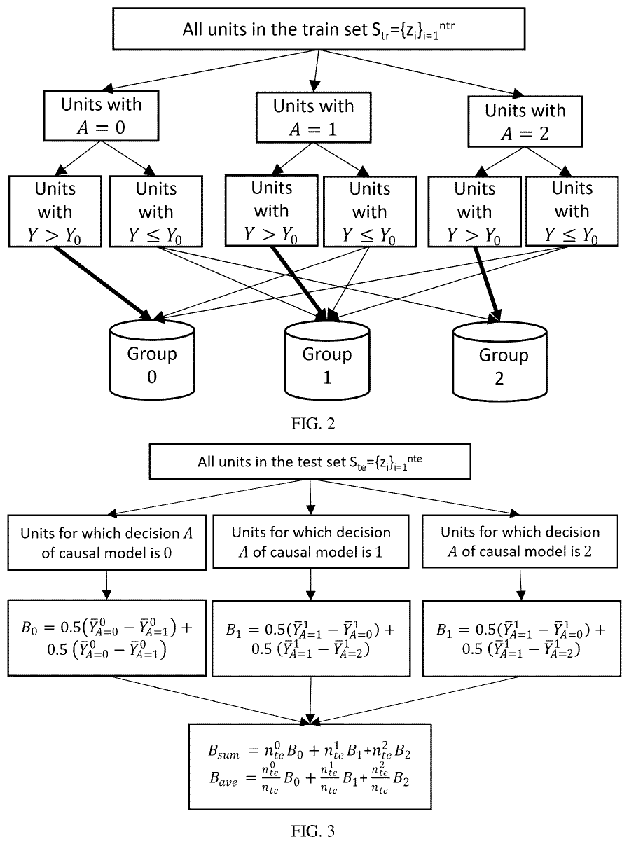

In some implementations, said process 104 includes, as shown in FIG. 2, calculating the decision causal utility for each unit based on the decision causal utility function B=B(z), the proposed decision group label of unit z, and the potential outcome difference tensor D(i,j,k). The decision causal utility function is the median of the i-th column with the i-th row element removed from the potential outcome difference matrix D_i of the group i where unit z belongs. Specifically:
For units in proposed feminized group 0: $B_0=0.5(Y_0\hat{ }{A=0}−Y_0\hat{ }{A=1})+0.5(Y_0\hat{ }{A=0}−Y_0\hat{ }{A=2})$
For units in proposed masculinized group 1: $B_1=0.5(Y_1\hat{ }{A=1}−Y_1\hat{ }{A=0})+0.5(Y_1\hat{ }{A=1}−Y_1\hat{ }{A=2})$
For units in proposed random-gender group 2: $B_2=0.5(Y_2\hat{ }{A=2}−Y_2\hat{ }{A=0})+0.5(Y_2\hat{ }{A=2}−Y_2\hat{ }{A=1})$
The total decision causal utility for all units is the sum: $B_{sum}=n_0B_0+n_1B_1+n_2B_2$
The average decision causal utility is: $B_{ave}=B_{sum}/n$

The experiment was repeated 100 times and averaged. The results show that the model $f_1$ trained with the learning method of this embodiment increased media news likes from 0.74 to 0.92 (average causal decision utility=+0.18 likes), while the control model $f_0$ decreased media news likes from 0.74 to 0.65 (average causal decision utility =−0.09 likes).

Although the above two embodiments describe certain terms to refer to features of the system or actions performed by the system, it should be understood that these terms are not the only terms that may be used to describe the operation of the system. Alternative terminology may also be employed without departing from the scope of the present disclosure. Some non-limiting examples of such alternative terms are as follows. For instance, “unit” may alternatively be referred to as “cell,” “instance,” “individual,” or “element.” “Feature variable” may alternatively be referred to as “covariate” or “independent variable.” “Decision variable” may alternatively be referred to as “intervention variable,” “treatment variable,” or “intervention.” “Target variable” may alternatively be referred to as “outcome variable,” “result variable,” or “variable of interest.” “Environment” may alternatively be referred to as “context,” “setting,” “state,” or “system.” “Randomized experiment” may alternatively be referred to as an “A/B test.”

Although the foregoing embodiments describe the use of decision variables, feature variables, and outcome variables having specific dimensions, cardinalities, and types, it should be understood that straightforward extensions of the disclosed evaluation and learning methods to other dimensions, cardinalities, and types of such variables also fall within the scope of the present invention. For example, the cardinality of one-dimensional decision variables is not limited to binary or ternary values; the cardinality of high-dimensional decision variables may be determined by traversing grid points in a high-dimensional space. Continuous (non-discrete) decision variables may be encoded as discrete variables using discretization methods such as equal-width discretization, equal-frequency discretization, clustering-based discretization, decision tree-based discretization, optimal split-point discretization, or user-defined segmented discretization. The dimensionality of feature variables may be expanded by collecting more diverse and multi-dimensional attributes of the units. Furthermore, the concept of a “target threshold” for the outcome variable can be naturally generalized to a “target hyperplane.” The data types of the decision, feature, and outcome variables are not limited to numerical, categorical, textual, or tabular forms, but may also include encoded graphics, images, video, audio, animations, actions of other triggers (e.g., webpage or application displays), measurements from other sensors, or any combination thereof.

The term “repeatedly,” i.e., in the context of repeatedly performing an operation is generally used in this specification to mean that the operation is occurring multiple times with or without a specific sequence. As an example, a process may constantly or iteratively follow a set of steps/processes in a specified order or the steps/process may be followed randomly or non-sequentially. Additionally, steps/process may not all be executed with the same frequency, for example causal model evaluation may be executed more frequently than updating the causal model, and the frequency of the latter may change over time, for example as exploit phase becomes dominant and/or as computing capacity/speed requirements change over time.

In the present disclosure, the term “randomization” refers to the process of assigning values to specific variables or conducting certain actions or interventions based on random numbers generated through a process that possesses randomness. For example, a decision may be made to display a pop-up based on the result of a coin toss, to issue a coupon based on thermal noise from a computer, or to make an investment based on a true random number generated by a quantum device. The randomization process is characterized by randomness, unpredictability, and non-repeatability. Where necessary, pseudorandom numbers may be used as a substitute. For example, the content to be pushed may be determined using pseudorandom numbers generated from a computer-based random number table.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs. The one or more computer programs can comprise one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs. The one or more computer programs can comprise one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them.

Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method to evaluate and learning a causal model for personalized decision-making system, comprising: repeatedly performing the following: (a) perform a program to evaluate the causal model for personalized decision-making system, (b) perform a program to learning the causal model for personalized decision-making system.

2. The method of claim 1, wherein (a) comprises:
process 101, obtaining a causal model f and a test dataset S_{te}={z_i} where i from 1 to n_{te}, each unit z_i comprising a feature vector X, a randomized decision variable A, and an outcome Y;
process 102, inputting X of each unit into f to obtain a proposed decision G, and grouping units by identical G values;
process 103, for each group i, computing a potential outcome difference matrix D_i(j,k)=E[Y|A=k]−E[Y|A=j];
process 104, computing a causal utility of f for each unit based on a causal utility function B(z), group assignment G, and D_i(j,k).

3. The method of claim 1, wherein (a) comprises:
process 101, obtaining a causal model f and a test dataset S_{te}={z_i} where i from 1 to n_{te}, each unit z_i comprising a feature vector X, a randomized decision variable A, and an outcome Y;
process 102, inputting X of each unit into f to obtain a proposed decision G, and grouping units by identical G values;
process 103, for each group i, computing a potential outcome difference matrix D_i(j,k)=E[Y|A=k]−E[Y|A=j];
process 104, computing a causal utility of f for each unit based on a causal utility function B(z), group assignment G, and D_i(j,k);
and wherein process 101 comprises:
X represents pre-decision feature variables,
A is a randomized decision variable generated prior to evaluation, and
Y represents an outcome variable observed after applying decision A;
wherein X and A each comprise at least one data type selected from the group consisting of: numerical, categorical, textual, and tabular data; and encoding the feature variables X, decision variables A, and outcome variables Y.

4. The method of claim 1, wherein (a) comprises:
process 101, obtaining a causal model f and a test dataset S_{te}={z_i} where i from 1 to n_{te}, each unit z_i comprising a feature vector X, a randomized decision variable A, and an outcome Y;
process 102, inputting X of each unit into f to obtain a proposed decision G, and grouping units by identical G values;
process 103, for each group i, computing a potential outcome difference matrix D_i(j,k)=E[Y|A=k]−E[Y|A=j];
process 104, computing a causal utility of f for each unit based on a causal utility function B(z), group assignment G, and D_i(j,k);
and wherein process 102 comprises:
inputting the feature vector X of each test unit into the causal model f to obtain a proposed decision label G,
assigning test units having identical values of G to a common group,
wherein G takes integer values from 0 to M−1, and M is the number of possible values for both the decision variable A and the proposed decision label G.

5. The method of claim 1, wherein (a) comprises:
process 101, obtaining a causal model f and a test dataset S_{te}={z_i} where i from 1 to n_{te}, each unit z_i comprising a feature vector X, a randomized decision variable A, and an outcome Y;
process 102, inputting X of each unit into f to obtain a proposed decision G, and grouping units by identical G values;
process 103, for each group i, computing a potential outcome difference matrix D_i(j,k)=E[Y|A=k]−E[Y|A=j];
process 104, computing a causal utility of f for each unit based on a causal utility function B(z), group assignment G, and D_i(j,k);
and wherein process 103 comprises:
for each group i, generating an M×M difference matrix D_i wherein:
each element D_i(j,k) at row j and column k is computed as:
$$D\_i ( j , k ) = mu ( Y \vert A = k , Group = i ) - mu ( Y \vert A = j , Group = i )$$
where mu(⋅) is a central tendency measure calculated exclusively from units in group i with decision variable A matching the respective conditional value.

6. The method of claim 1, wherein (a) comprises:
process 101, obtaining a causal model f and a test dataset S_{te}={z_i} where i from 1 to n_{te}, each unit z_i comprising a feature vector X, a randomized decision variable A, and an outcome Y;
process 102, inputting X of each unit into f to obtain a proposed decision G, and grouping units by identical G values;
process 103, for each group i, computing a potential outcome difference matrix D_i(j,k)=E[Y|A=k]−E[Y|A=j];
process 104, computing a causal utility of f for each unit based on a causal utility function B(z), group assignment G, and D_i(j,k);
and wherein process 104 comprises:
for each unit z assigned to group i:
selecting column i from the difference matrix D_i;
extracting all non-diagonal elements D_i(j,i) where j is not equal to i;
computing the causal utility function B(z) by applying a central tendency operator to the extracted elements,
wherein the central tendency operator is selected from the group consisting of:
arithmetic mean, median, and maximum value.

7. The method of claim 1, wherein (b) comprises:
process 201, retrieve a training dataset S_{tr}={z_i} where i from 1 to n_{tr}, wherein each unit z_i comprises a feature vector X, a randomized decision variable A, and an observed outcome Y;
process 202, compute a threshold Y_0 over the outcome variable Y using a target threshold function F(Y);
process 203, assign each unit an optimal group label G based on decision A, outcome Y, and threshold Y_0; and
process 204, dynamically update the parameters of a causal model f: from X to G, based on the feature vectors X and group labels G.

8. The method of claim 1, wherein (b) comprises:
process 201, retrieve a training dataset S_{tr}={z_i} where i from 1 to n_{tr}, wherein each unit z_i comprises a feature vector X, a randomized decision variable A, and an observed outcome Y;
process 202, compute a threshold Y_0 over the outcome variable Y using a target threshold function F(Y);
process 203, assign each unit an optimal group label G based on decision A, outcome Y, and threshold Y_0; and
process 204, dynamically update the parameters of a causal model f: from X to G, based on the feature vectors X and group labels G;
wherein each data unit (X, A, Y) is encoded in process 201 such that:
X represents pre-decision features;
A is a randomized decision variable;
Y is an outcome observed after A; and
X and A include one or more of numerical, categorical, tabular, or textual data formats.

9. The method of claim 1, wherein (b) comprises:
process 201, retrieve a training dataset S_{tr}={z_i} where i from 1 to n_{tr}, wherein each unit z_i comprises a feature vector X, a randomized decision variable A, and an observed outcome Y;
process 202, compute a threshold Y_0 over the outcome variable Y using a target threshold function F(Y);
process 203, assign each unit an optimal group label G based on decision A, outcome Y, and threshold Y_0; and
process 204, dynamically update the parameters of a causal model f: from X to G, based on the feature vectors X and group labels G;
wherein the process 202 determines a multi-dimensional threshold Y_0=[Y_0\hat{ }1, . . . ,Y_0\hat{ }{D_Y}] using the function F(Y), wherein F comprises one or more sample statistical methods selected from:
(i) maximum-M quantiles of Y; or
(ii) equal-width partitioning of the Y value range,
wherein M is the number of possible values of decision variable A.

10. The method of claim 1, wherein (b) comprises:
process 201, retrieve a training dataset S_{tr}={z_i} where i from 1 to n_{tr}, wherein each unit z_i comprises a feature vector X, a randomized decision variable A, and an observed outcome Y;
process 202, compute a threshold Y_0 over the outcome variable Y using a target threshold function F (Y);
process 203, assign each unit an optimal group label G based on decision A, outcome Y, and threshold Y_0; and
process 204, dynamically update the parameters of a causal model f: from X to G, based on the feature vectors X and group labels G;
wherein the group label G in the process 203 for each unit is generated by:
(i) assign a unit to group i if A=i and Y≤Y_0; and
(ii) assign a unit to one of the remaining M−1 groups if A=i and Y≤Y_0,
wherein the assignment in (b) is performed using a residual assignment rule R(A, Y), comprising either:
(i) random allocation with equal probability across the other groups; or
(ii) sequential allocation based on the sorted order of Y values.

11. The method of claim 1, wherein (b) comprises:
process 201, retrieve a training dataset S_{tr}={z_i} where i from 1 to n_{tr}, wherein each unit z_i comprises a feature vector X, a randomized decision variable A, and an observed outcome Y;
process 202, compute a threshold Y_0 over the outcome variable Y using a target threshold function F(Y);
process 203, assign each unit an optimal group label G based on decision A, outcome Y, and threshold Y_0; and
process 204, dynamically update the parameters of a causal model f: from X to G, based on the feature vectors X and group labels G;
wherein the process 204 is configured to train a prediction model f: from X to G, using the feature vectors X and optimal group labels G, and further configured to evaluate f using one or more prediction metrics selected from:
precision, recall, F1-score, PR-AUC, or ROC-AUC;
and wherein, during inference, the system applies the trained model f to generate a group label G and selects the corresponding decision A in a one-to-one mapping.

12. A system comprising one or more computers and one or more storage devices storing instructions that when executed by the one or more computers cause the one or more computers to perform the operations of the respective method:
repeatedly performing the operations of the following: (a) perform a program to evaluate the causal model for personalized decision-making system, (b) perform a program to learning the causal model for personalized decision-making system.

13. The system of claim 12, wherein (a) comprises:
process 101, obtaining a causal model f and a test dataset S_{te}={z_i} where i from 1 to n_{te}, each unit z_i comprising a feature vector X, a randomized decision variable A, and an outcome Y;
process 102, inputting X of each unit into f to obtain a proposed decision G, and grouping units by identical G values;
process 103, for each group i, computing a potential outcome difference matrix D_i(j,k)=E[Y|A=k]−E[Y|A=j];
process 104, computing a causal utility of f for each unit based on a causal utility function B(z), group assignment G, and D_i(j,k).

14. The system of claim 12, wherein (b) comprises:
process 201, retrieve a training dataset S_{tr}={z_i} where i from 1 to n_{tr}, wherein each unit z_i comprises a feature vector X, a randomized decision variable A, and an observed outcome Y;
process 202, compute a threshold Y_0 over the outcome variable Y using a target threshold function F(Y);
process 203, assign each unit an optimal group label G based on decision A, outcome Y, and threshold Y_0; and
process 204, dynamically update the parameters of a causal model f: from X to G, based on the feature vectors X and group labels G.

15. One or more computer-readable storage media storing instructions that when executed by one or more computers cause the one or more computers to perform the operations of the respective method or system:
repeatedly perform the operations of the following method: (a) perform a program to evaluate the causal model for personalized decision-making system, (b) perform a program to learning the causal model for personalized decision-making system;
repeatedly perform the operations of the following system: a system comprising one or more computers and one or more storage devices storing instructions that when executed by the one or more computers cause the one or more computers to perform the operations of the respective method: repeatedly performing the following: (a) perform a program to evaluate the causal model for personalized decision-making system, (b) perform a program to learning the causal model for personalized decision-making system.

16. The storage media of claim 15, wherein (a) comprises:
process 101, obtaining a causal model f and a test dataset S_{te}={z_i} where i from 1 to n_{te}, each unit z_i comprising a feature vector X, a randomized decision variable A, and an outcome Y;
process 102, inputting X of each unit into f to obtain a proposed decision G, and grouping units by identical G values;
process 103, for each group i, computing a potential outcome difference matrix D_i(j,k)=E[Y|A=k]−E[Y|A=j];
process 104, computing a causal utility of f for each unit based on a causal utility function B(z), group assignment G, and D_i(j,k).

17. The storage media of claim 15, wherein (b) comprises:
process 201, retrieve a training dataset S_{tr}={z_i} where i from 1 to n_{tr}, wherein each unit z_i comprises a feature vector X, a randomized decision variable A, and an observed outcome Y;
process 202, compute a threshold Y_0 over the outcome variable Y using a target threshold function F(Y);
process 203, assign each unit an optimal group label G based on decision A, outcome Y, and threshold Y_0; and
process 204, dynamically update the parameters of a causal model f: from X to G, based on the feature vectors X and group labels G.
